(19) United States
(12) Patent Application Publication
(10) Pub. No.: US 2024/0229891 A1
(43) Pub. Date: Jul. 11, 2024

(54) DAMPING FORCE GENERATION STRUCTURE

(71) Applicant: Hitachi Astemo, Ltd., Hitachinaka-shi (JP)

(72) Inventors: Yosuke MURAKAMI, Hitachinaka-shi (JP); Daisuke MICHIURA, Hitachinaka-shi (JP)

(73) Assignee: Hitachi Astemo, Ltd., Hitachinaka-shi (JP)

(21) Appl. No.: 18/617,096

(22) Filed: Mar. 26, 2024

Related U.S. Application Data
(63) Continuation of application No. PCT/JP2022/020157, filed on May 13, 2022.

(30) Foreign Application Priority Data
Nov. 15, 2021 (JP) 2021-185889

(51) Int. Cl. F16F 9/50

(52) U.S. Cl. CPC F16F 9/50

(57) ABSTRACT

A damping force generation structure includes a damping force generation mechanism, and a damping force adjustment mechanism. The damping force adjustment mechanism includes a drive mechanism configured to be able to drive the valve body, and a coupling member having a first end fixed to the drive mechanism and a second end fixed to the fixing member, thereby coupling the drive mechanism and the fixing member. At least one of a position of the damping force generation mechanism relative to the fixing member, a position of the coupling member relative to the fixing member, and a position of the drive mechanism relative to the coupling member is adjustable in the advancing and retracting direction of the valve body by a position adjustment mechanism.

### CROSS-REFERENCE TO RELATED APPLICATIONS

This is a continuation of International Application No. PCT/JP2022/020157 filed on May 13, 2022, and claims the benefit of priority under 35 USC §119 to Japanese Patent Application No. 2021-185889 filed on Nov. 15, 2021, the entire contents of all of which are incorporated herein by reference.

### FIELD OF THE INVENTION

The present disclosure relates to a damping force generation structure which can adjust a damping force.

### BACKGROUND OF THE INVENTION

A saddle-type vehicle represented by a two-wheeled vehicle or a three-wheeled vehicle is provided with a hydraulic shock absorber connected to an axle and a vehicle body to absorb vibration from a road surface. JP H10-061707 A discloses a technique related to such a hydraulic shock absorber in the related art.

The hydraulic shock absorber disclosed in JP H10-061707 A includes a cylindrical cylinder, a piston defining an oil chamber in the cylinder, a rod having a lower end fixed to the piston, and a rod guide fixed to an upper end of the cylinder to guide movement of the rod.

The cylinder is surrounded by a cylindrical pipe. The space between the cylinder and the pipe serves as a compensation chamber which compensates for the volume of oil in the cylinder when the rod moves.

A damping force generation structure is provided on a lateral side of the pipe, and the damping force generation structure can generate a damping force by communicating with the oil chamber in the cylinder. The damping force generation structure includes a damping force generation mechanism having a flow path through which oil flows from the oil chamber in the cylinder, and a damping force adjustment mechanism capable of adjusting a flow path area of the flow path of the damping force generation mechanism.

The damping force adjustment mechanism includes an electromagnetic coil, a conductive annular member, and a shaft member fixed to the annular member. When electricity is supplied to the electromagnetic coil, a magnetic field is generated, the shaft member moves together with the annular member in a direction along an axis of the shaft member, and positions of a valve body of the shaft member and a valve seat facing the valve body change. The damping force can be adjusted by changing the flow path area of the oil according to the position of the shaft member.

The damping force generation structure includes the damping force generation mechanism and the damping force adjustment mechanism, and a plurality of components are assembled to each other. A dimension of each of the components is allowed to vary (dimensional tolerance), and thus, when states of the individual products immediately after assembly are compared, an interval between the valve body and the valve seat may vary. When the interval between the valve body and the valve seat varies, characteristics of the damping force adjustment change depending on the products.

The hydraulic shock absorber of JP H10-061707 A is provided with an adjustment member capable of adjusting the position of the shaft member in the axial direction by operation from the outside. Even when the interval between the valve body and the valve seat varies in the individual products, the positions of the valve body and the valve seat can be adjusted by the adjustment member. However, since the number of components increases, the manufacturing cost also increases. It is desirable that the interval between the valve body and the valve seat can be adjusted without using the adjustment member which adjusts the interval from the outside.

### SUMMARY OF THE INVENTION

An object of the present invention is to provide a damping force generation structure which can adjust a position of a component which adjusts a damping force while reducing the number of components.

As a result of intensive studies, the present inventors have found that it is possible to provide a damping force generation structure including a damping force generation mechanism having a valve seat and a damping force adjustment mechanism having a valve body, in which the damping force generation mechanism and the damping force adjustment mechanism are fixed to each other along an advancing and retracting direction of the valve body via a fixing member, a drive mechanism of the damping force adjustment mechanism and the fixing member are coupled by a coupling member, and at least one of a position of the damping force generation mechanism relative to the fixing member, a position of the coupling member relative to the fixing member, and a position of the drive mechanism relative to the coupling member is adjusted in the advancing and retracting direction of the valve body by a position adjustment mechanism, the number of components is limited, and a position of a component which adjusts the damping force can be adjusted. The present invention is completed based on these findings.

According to the present disclosure, there is provided a damping force generation structure including: a damping force generation mechanism having a valve seat and configured to generate a damping force; and a damping force adjustment mechanism having a valve body advanceable and retractable relative to the valve seat, and configured to be able to adjust the damping force generated by the damping force adjustment mechanism. The damping force generation mechanism and the damping force adjustment mechanism are fixed to each other via a fixing member along an advancing and retracting direction of the valve body. The damping force adjustment mechanism includes a drive mechanism configured to be able to drive the valve body, and a coupling member having a first end fixed to the drive mechanism and a second end fixed to the fixing member, thereby coupling the drive mechanism and the fixing member. At least one of a position of the damping force generation mechanism relative to the fixing member, a position of the coupling member relative to the fixing member, and a position of the drive mechanism relative to the coupling member is adjustable in the advancing and retracting direction of the valve body by a position adjustment mechanism.

The damping force generation mechanism and the fixing member may be integrated.

The drive mechanism may include a drive shaft configured to advance and retract the valve body, and a transmission member which transmits a force generated by the drive mechanism from the drive shaft to the valve body may be disposed between the drive shaft and the valve body.

The position which is adjustable by the position adjustment mechanism may be regulated by a regulation member.

The position adjustment mechanism may have a female thread and a male thread configured to be able to mesh with the female thread.

The male thread and the female thread may be fixed to each other by being located in a reference position and rotating the male thread or the female thread in a direction of loosening the male thread and the female thread from the reference position.

The reference position may be a fully closed position in which the valve body is in contact with the valve seat, or a fully open position in which an interval between the valve body and the valve seat is largest.

The damping force generation structure may be provided in a shock absorber.

According to the present disclosure, it is possible to provide a damping force generation structure which can adjust a position of a component which adjusts a damping force while reducing the number of components.

### BRIEF DESCRIPTION OF THE DRAWINGS

FIG. 1 is a side view of a two-wheeled vehicle including a hydraulic shock absorber having a damping force generation structure according to a first embodiment.

FIG. 2 is a cross-sectional view of the hydraulic shock absorber illustrated in FIG. 1.

FIG. 3 is an enlarged view of a portion surrounded by a line 3 in FIG. 2.

FIG. 4 is an exploded view of the damping force generation structure of the hydraulic shock absorber illustrated in FIG. 1.

FIG. 5 is an enlarged view of a portion surrounded by a line 5 in FIG. 2.

FIG. 6 illustrates operation of a first position adjustment mechanism and a second position adjustment mechanism.

FIG. 7 illustrates operation of a third position adjustment mechanism.

FIG. 8 illustrates a configuration of a first position adjustment mechanism of a damping force generation structure according to a third embodiment.

### DETAILED DESCRIPTION OF THE INVENTION

Embodiments of the present invention will be described below with reference to the accompanying drawings. Up in the drawings indicates up and Dn indicates down.

### First Embodiment

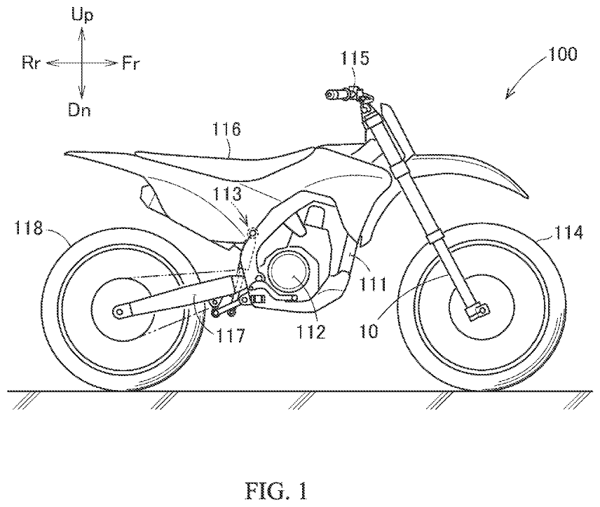

Reference is made to FIG. 1. A shock absorber 10 is, for example, a front suspension (front fork) used in an off-road two-wheeled vehicle 100 (saddle-type vehicle 100). Hereinafter, the shock absorber 10 will be referred to as the front suspension 10.

The two-wheeled vehicle 100 includes a vehicle body 111, an engine 112 which is a power source supported at a central lower portion of the vehicle body 111, left and right front suspensions 10 (only the front suspension 10 on a right side is illustrated in FIG. 1) which are provided on left and right sides of a front portion of the vehicle body 111 and absorb a shock received from unevenness of a road surface, a front wheel 114 sandwiched between and rotatably supported by lower ends of the front suspensions 10, a handlebar pipe 115 which is disposed above the front suspensions 113 and steers the front wheel 114, a seat 116 which is provided above the engine 112 and allows an occupant to sit thereon, a swing arm 117 which extends rearward from a rear portion of the vehicle body 111 and is swingable relative to the vehicle body 111, a rear wheel 118 rotatably supported by a rear end of the swing arm 117, and left and right rear suspensions 113 (only the rear suspension 113 on a left side is illustrated in FIG. 1) which stretch from the rear portion of the vehicle body 111 to the swing arm 117.

The left and right front suspensions 10 have the same configuration. Hereinafter, the right front suspension 10 will be described, and description of the left front suspension will be omitted. The left and right front suspensions 10 may have different configurations depending on purposes.

For convenience of the following description, a vehicle body 111 side is referred to as an upper side, and a front wheel 114 side is referred to as a lower side. An up-down direction is a direction in which an axis of a cylinder 11 to be described later extends, and may also be referred to as an advancing and retracting direction of a valve body 61 to be described later.

### (Shock Absorber)

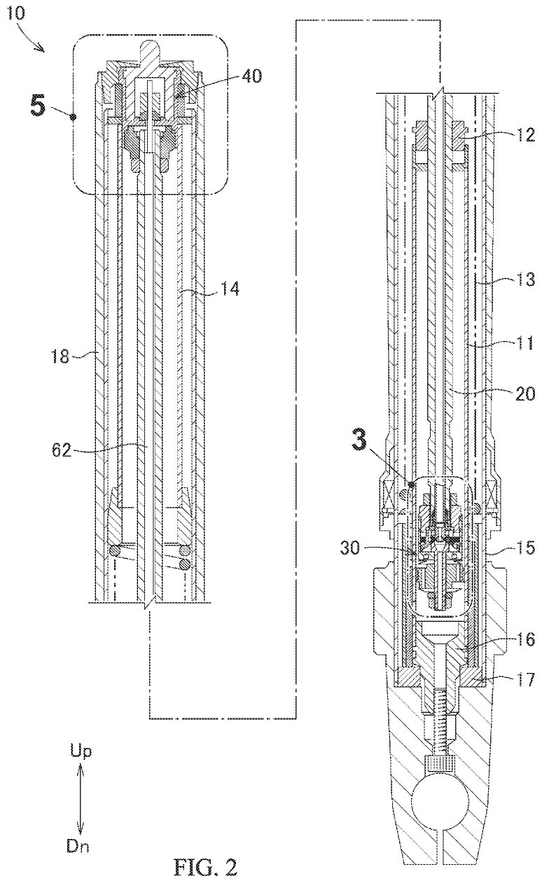

Reference is made to FIG. 2. The front suspension 10 includes the cylinder 11 extending in the up-down direction, a damping force generation structure 30 disposed inside the cylinder 11, a rod 20 which extends in the up-down direction and has a lower end fixed to the damping force generation structure 30, a rod guide 12 which blocks an upper end of the cylinder 11 and guides movement of the rod 20 in an axial direction (up-down direction in the drawing) of the cylinder 11, a suspension spring 13 surrounding the cylinder 11, and a cylindrical spring receiver 14 supporting an upper end of the suspension spring 13.

The cylinder 11 is housed in an inner tube 15. The cylinder 11 has a lower end blocked by a blocking member 16. The blocking member 16 penetrates an annular cap 17. The cap 17 blocks a lower end of the inner tube 15 together with the blocking member 16.

The inner tube 15 is provided with an outer tube 18 on an upper side, and the outer tube 18 has an inner circumferential surface slidable relative to an outer circumferential surface of the inner tube 15. The outer tube 18 is provided with a drive mechanism 40 at an upper end, and the drive mechanism 40 drives a damping force adjustment mechanism 60 to be described later.

### (Damping Force Generation Structure)

When the damping force generation structure 30 moves in the up-down direction relative to the cylinder 11, a fluid (oil) flows in the cylinder 11 and a damping force is generated. The damping force generation structure 30 is not limited to a structure which moves relative to the cylinder 11.

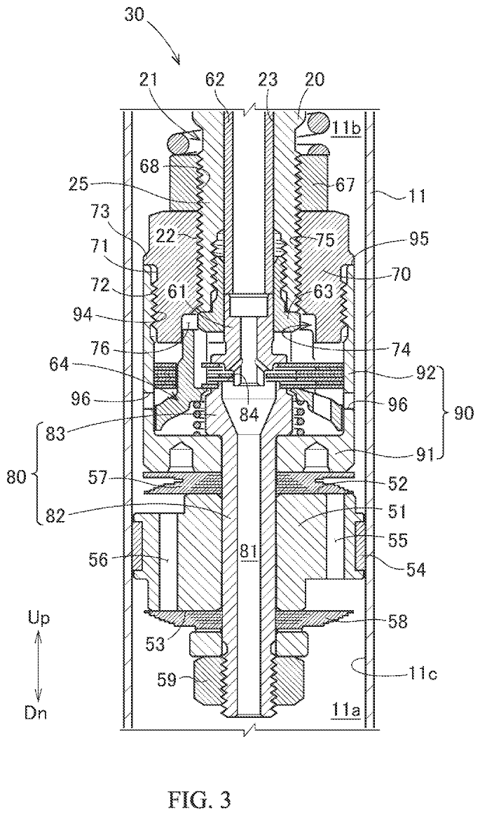

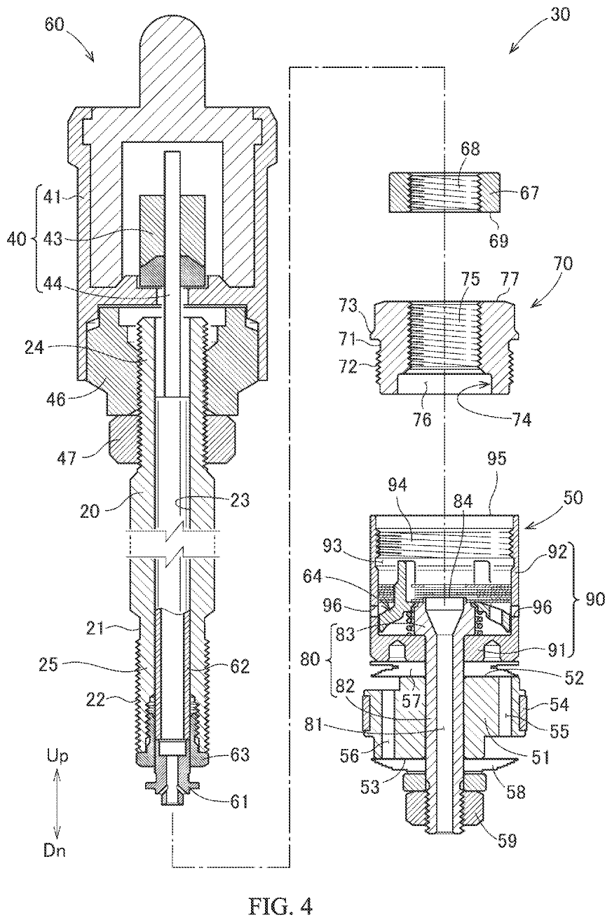

Reference is made to FIGS. 3 and 4. The damping force generation structure 30 includes a damping force generation mechanism 50 which generates a damping force, the damping force adjustment mechanism 60 which can adjust the damping force of the damping force generation mechanism 50, and a fixing member 70 which fixes the damping force generation mechanism 50 and the damping force adjustment mechanism 60 to each other in the up-down direction.

### (Damping Force Generation Mechanism)

The damping force generation mechanism 50 includes a columnar piston 51 slidable relative to an inner circumferential surface of the cylinder 11, a flow path member 80 which supports the piston 51 and is formed with a flow path 81 through which oil flows, and a base member 90 to which the flow path member 80 is attached.

### (Piston)

The piston 51 partitions the inside of the cylinder 11 into a first chamber 11a below the piston 51 and a second chamber 11b above the piston 51. The piston 51 is provided with an O-ring 54 in a groove formed in an outer circumferential surface thereof. The 0-ring 54 is in contact with an inner circumferential surface 11c of the cylinder 11.

The piston 51 has communication passages 55, 56 which allow the first chamber 11a and the second chamber 11b to communicate with each other. Each of the communication passages 55, 56 penetrates the piston 51 in the up-down direction.

The communication passage 55 is openable and closable by a valve 57 disposed on an upper end surface 52 of the piston 51. The valve 57 is implemented by a plurality of overlapped circular plates. Each of the circular plates is formed of spring steel and is elastically deformable.

The communication passage 56 is openable and closable by a valve 58 disposed on a lower end surface 53 of the piston 51. The valve 58 is implemented by a plurality of overlapped circular plates. Each of the circular plates is formed of spring steel and is elastically deformable. The valve 58 is sandwiched between the lower end surface 53 of the piston 51 and a nut 59.

### (Flow Path Member)

The flow path member 80 has a bolt shape as a whole. Specifically, the flow path member 80 integrally includes a shaft portion 82 extending in the up-down direction and a head portion 83 which is located at an upper end of the shaft portion 82 and has a diameter larger than that of the shaft portion 82. The flow path 81 of the flow path member 80 is a hole formed in the up-down direction from an upper end of the head portion 83 to a lower end of the shaft portion 82. The upper end of the head portion 83 is a valve seat 84.

### (Base Member)

The base member 90 integrally includes a circular plate-shaped bottom portion 91 that the shaft portion 82 of the flow path member 80 penetrates and a cylindrical portion 92 extending upward from a circumferential edge of the bottom portion 91.

The bottom portion 91 of the base member 90 and the upper end surface 52 of the piston 51 have the valve 57 sandwiched in between. The cylindrical portion 92 has, in an inner circumferential surface 93, a first male thread 94 formed with a female thread. The cylindrical portion 92 has communication holes 96, 96 through which the inside of the cylindrical portion 92 communicates with the second chamber llb of the cylinder 11.

### (Damping Force Adjustment Mechanism)

The damping force adjustment mechanism 60 includes the drive mechanism 40 which can drive the valve body 61 advanceable and retractable relative to the valve seat 84, and the rod 20 (coupling member) having an upper end portion 24 (first end) fixed to the drive mechanism 40 and a lower end portion 25 (second end) fixed to the fixing member 70.

A transmission member 62 is disposed between a drive shaft 44 of the drive mechanism 40 and the valve body 61. The transmission member 62 transmits a force generated by the drive mechanism 40 to the valve body 61. The transmission member 62 is an elongated member extending in a movement direction of the valve body 61, and has an upper end portion in contact with the drive shaft 44 and a lower end portion in contact with the valve body 61. The transmission member 62 is housed inside the hollow rod 20. A part of the drive shaft 44 is also located inside the rod 20.

The base member 90 is provided therein with a pressing mechanism 64 which applies a force to the valve body 61 to move the valve body 61 upward by a force of a coil spring.

The lower end portion 25 of the rod 20 is provided with a bearing 63 which supports the valve body 61 and the rod 20. An inner circumferential surface 23 of the rod 20 guides the movement of the transmission member 62 in the up-down direction.

An outer circumferential surface 21 of the lower end portion 25 of the rod 20 of the damping force adjustment mechanism 60 has a second male thread 22.

### (Fixing Member And First Regulation Member)

The fixing member 70 is an annular member. The fixing member 70 includes, at an outer circumferential surface 71, a first male thread 72 which can mesh with the first male thread 94 of the cylindrical portion 92, and a large diameter portion 73 (first regulation member) which is located at an upper end of the first male thread 72 and has a diameter larger than a diameter of the first male thread 72.

The fixing member 70 includes, at an inner circumferential surface 74, a second male thread 75 which can mesh with the second male thread 22 of the rod 20, and a guide portion 76 which is located below the second male thread 75 and guides the movement of the pressing mechanism 64.

### (Second Regulation Member)

A position of the rod 20 (coupling member) relative to the fixing member 70 can be regulated by a second regulation member 67. The second regulation member 67 is, for example, a nut. The second regulation member 67 has a female thread 68 which can mesh with the second male thread 22 of the rod 20.

### (Drive Mechanism)

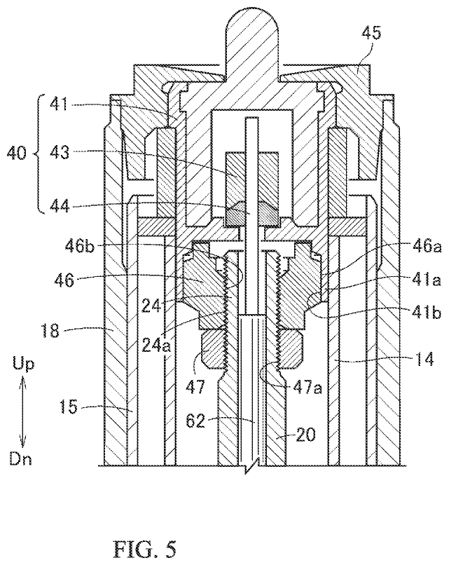

Reference is made to FIG. 5. The drive mechanism 40 includes a cylindrical case 41, a core and a coil (not illustrated) housed in the case 41, a yoke 43 disposed inside the core, and the drive shaft 44 (plunger) supported by the yoke 43. As long as the drive mechanism 40 includes the drive shaft 44 which advances and retracts in the up-down direction (one axial direction) to move the valve body 61 (see FIG. 4) in the up-down direction, a type thereof is not limited, and a known technique can be adopted. Detailed description of the drive mechanism 40 will be omitted. The case 41 is attached to a cap 45 which blocks the upper end of the outer tube 18.

The drive mechanism 40 and the upper end portion 24 of the rod 20 are fixed to each other via a second fixing member 46. The second fixing member is an annular member. The second fixing member has an outer circumferential surface 46a fitted to an inner circumferential surface 41b of a lower portion (below a space in which the yoke 43 or the like is housed) of the case 41. An outer circumferential surface of the lower portion of the case 41 is fitted into the spring receiver 14.

The second fixing member 46 is formed with a third female thread 46b on an inner circumferential surface. A third male thread 24a which can mesh with the third female thread 46b is formed on an outer circumferential surface of the upper end portion of the rod 20.

A position of the second fixing member 46 relative to the rod 20 is regulated by a third regulation member 47. The third regulation member 47 is, for example, a nut, and is formed with a female thread 47a which can mesh with the third male thread. The second fixing member 46 has an inner diameter equal to an inner diameter of the third regulation member 47.

### (Effects of Embodiment)

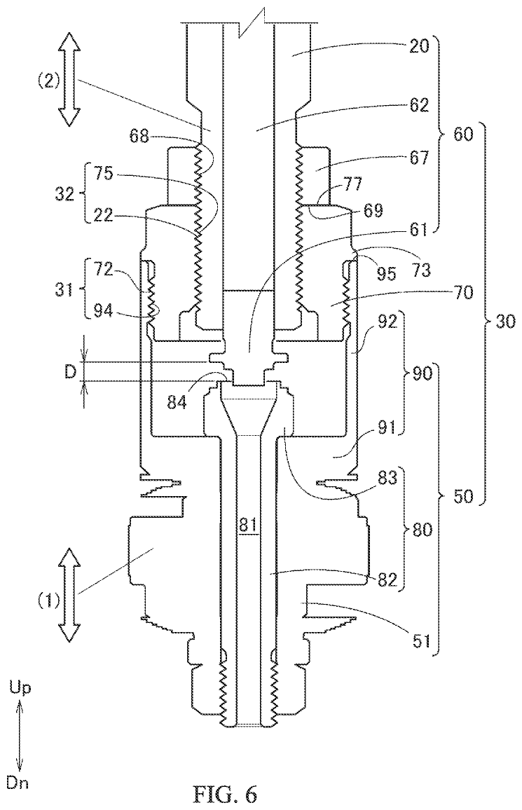

Reference is made to FIG. 6. The damping force generation mechanism 50 and the damping force adjustment mechanism 60 are fixed to each other in the up-down direction (the advancing and retracting direction of the valve body 61) via the fixing member 70.

### (Position Adjustment Mechanism)

A position of the damping force generation mechanism 50 relative to the fixing member 70 can be adjusted by a first position adjustment mechanism 31 with reference to the up-down direction (see an arrow (1)). A position of the rod 20 (coupling member) relative to the fixing member 70 can be adjusted by a second position adjustment mechanism 32 with reference to the up-down direction (see an arrow (2)).

That is, a distance between the damping force generation mechanism 50 including the valve seat 84 and the damping force adjustment mechanism 60 including the valve body 61 can be adjusted with reference to the up-down direction. Specifically, an interval D between the valve seat 84 of the damping force generation mechanism 50 and the valve body 61 of the damping force adjustment mechanism 60 can be adjusted. For this reason, even when there are variations in dimensions of components constituting the damping force generation structure 30, the interval D can be set at a design dimension by adjusting positions of the damping force generation mechanism 50 and the rod 20 by the first position adjustment mechanism 31 or the second position adjustment mechanism 32, and characteristics of the damping force adjustment of the damping force generation structure 30 can be kept constant.

### (Position Adjustment Using Female Thread And Male Thread)

The position adjustment mechanisms 31, 32 may be of any type as long as they can adjust positions with reference to the up-down direction.

For example, the first position adjustment mechanism 31 includes the first male thread 72 formed in the outer circumferential surface of the fixing member 70 and the first female thread 94 formed in the inner circumferential surface of the cylindrical portion 92. For this reason, the interval D between the valve body 61 and the valve seat 84 can be easily adjusted by relatively rotating the fixing member 70 or the cylindrical portion 92 (tightening or loosening the first male thread 72 and the first female thread 94).

Similarly, the second position adjustment mechanism 32 includes the second female thread 75 formed in the inner circumferential surface of the fixing member 70 and the second male thread 22 formed in the outer circumferential surface of the rod 20 at the lower end. For this reason, the interval D between the valve body 61 and the valve seat 84 can be easily adjusted by relatively rotating the fixing member 70 or the rod 20 (tightening or loosening the second female thread 75 and the second male thread 22).

### (First Regulation Member)

The fixing member 70 has, at the outer circumferential surface 71, the large diameter portion 73 (first regulation member) having a diameter larger than the diameter of the first male thread 72. The contact between an upper end surface 95 of the cylindrical portion 92 and the large diameter portion 73 (first regulation member) can regulate the position of the damping force generation mechanism 50 relative to the fixing member 70.

### (Second Regulation Member)

The damping force adjustment mechanism 60 includes the second regulation member 67 (for example, a nut) having the female thread 68 which can mesh with the second male thread 22 of the rod 20. The contact between an upper end surface 77 of the fixing member 70 and a lower end surface 69 of the second regulation member 67 (fixing by a so-called double nut) can regulate the position of the damping force adjustment mechanism 60 (specifically, the rod 20) relative to the fixing member 70.

### (Method for Adjusting Interval Between Valve Body And Valve Seat)

A method for adjusting the interval D between the valve body 61 and the valve seat 84 by the first position adjustment mechanism 31 will be described.

First, the base member 90 (component formed with a female thread) and the fixing member 70 (component formed with a male thread) are located in a reference position. The reference position is a fully closed position in which the valve body 61 is in contact with the valve seat 84, or a fully open position in which the interval D between the valve body 61 and the valve seat 84 is largest. In the reference position, the male thread and the female thread are tightened with a predetermined torque, and the damping force generation mechanism 50 and the damping force adjustment mechanism 60 do not move relative to each other. A thin plate-shaped valve may be provided between the valve body 61 and the valve seat 84 and is pressed against the valve seat 84.

Next, the damping force generation mechanism 50 or the fixing member 70 can be moved by a certain amount by rotating the damping force generation mechanism 50 or the fixing member 70 by a certain amount in a direction in which the male thread and the female thread are loosened, and as a result, the interval D is adjusted. Similarly, the interval D can also be adjusted by the second position adjustment mechanism 32.

### (Damping Force Adjustment Mechanism Including Transmission Member)

Even when the drive mechanism 40 is not disposed inside the cylinder 11 due to size restrictions in design, the drive mechanism 40 can be attached to the outside of the cylinder 11 since the transmission member 62 is disposed between the drive mechanism 40 and the valve body 61 as in the present embodiment. The transmission member 62 is an elongated component among components constituting the damping force adjustment mechanism 60, and has a large influence on the dimensional accuracy of the damping force adjustment mechanism 60, and is accordingly easy to have an influence on characteristics of a damping force. As described above, the damping force generation structure 30 according to the present embodiment is particularly suitable for a configuration including the elongated transmission member 62, since the position in the up-down direction can be adjusted.

### (Third Position Adjustment Mechanism)

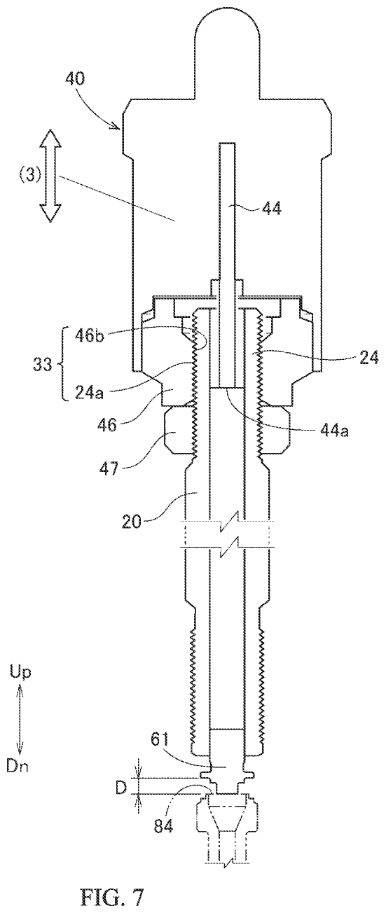

Reference is made to FIG. 7. The drive mechanism 40 and the upper end portion 24 of the rod 20 (coupling member) are fixed to each other via the second fixing member 46. The position of the drive mechanism 40 relative to the rod 20 can be adjusted with reference to the up-down direction (see an arrow (3)) by a third position adjustment mechanism 33.

Specifically, when the position of the drive mechanism 40 relative to the rod 20 is adjusted by the third position adjustment mechanism 33, the position of a distal end surface 44a of the drive shaft 44 relative to the rod 20 changes. When the drive mechanism 40 is brought close to the rod 20 (when the drive mechanism 40 is moved downward), the distal end surface 44a of the drive shaft 44 moves downward, and the interval D is narrowed. When the drive mechanism 40 is moved away from the rod 20 (when the drive mechanism 40 is moved upward), the distal end surface 44a of the drive shaft 44 moves upward, and the interval D is increased. The interval D can be adjusted not only by the first position adjustment mechanism 31 and the second position adjustment mechanism 32 but also by the third position adjustment mechanism 33.

### (Position Adjustment Using Female Thread And Male Thread)

The third position adjustment mechanism 33 may be of any type as long as a position thereof can be adjusted with reference to the up-down direction. For example, the third position adjustment mechanism 33 includes the third female thread 46b formed in the inner circumferential surface of the second fixing member 46, and the third male thread 24a which is formed in the outer circumferential surface of the upper end portion 24 of the rod 20 and can mesh with the third female thread 46b. For this reason, the interval D between the valve body 61 and the valve seat 84 can be easily adjusted by relatively rotating the drive mechanism 40 or the rod 20 into which the second fixing member 46 is fitted (tightening or loosening the third female thread 46b and the third male thread 24a). The second fixing member 46 is a member fitted into the case 41 of the drive mechanism 40 and may be integrated with the drive mechanism 40.

### (Third Regulation Member)

The position of the second fixing member 46 relative to the rod 20 is regulated by the third regulation member 47 (for example, a nut) (fixing by a so-called double nut).

### Second Embodiment

As illustrated in FIGS. 3 and 4, the base member 90 of the damping force generation mechanism 50 and the fixing member 70 are separate from each other, and are fixed to each other by thread fastening. However, in a damping force generation structure according to a second embodiment, the base member 90 of the damping force generation mechanism 50 and the fixing member 70 may be integrated (not illustrated). In other words, the damping force generation mechanism 50 and the damping force adjustment mechanism 60 may be directly fixed to each other without the fixing member 70.

### Third Embodiment

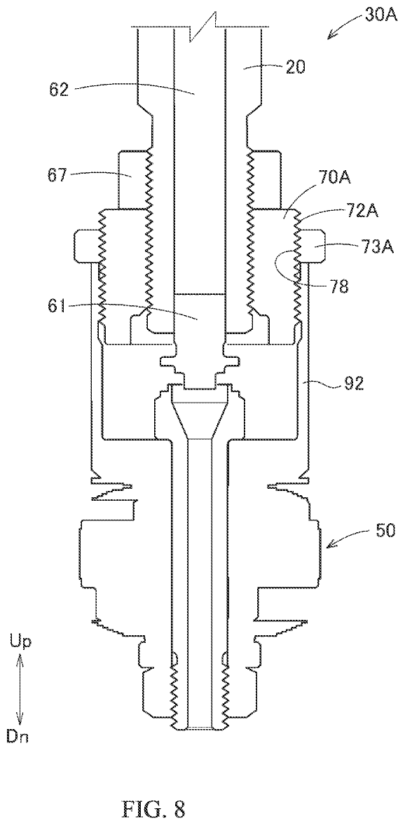

Reference is made to FIG. 4. In the first embodiment, the fixing member 70 includes the large diameter portion 73 (first regulation member) having a diameter larger than the diameter of the first male thread 72. However, as illustrated in FIG. 8, a first regulation member 73A (for example, a nut) which is attachable to the fixing member 70A may be used as a first regulation member of a damping force generation structure 30A according to a third embodiment. The second regulation member 73A has a female thread 78 which can mesh with a first male thread 72A of the fixing member 70A. The contact between the upper end surface 95 of the cylindrical portion 92 and the second regulation member 73A can regulate the position of the damping force generation mechanism 50 relative to the fixing member 70A.

The present invention is not limited to the embodiments as long as the functions and effects of the present invention are exhibited. In the damping force generation structure of the embodiments, the description is made using “valve body”, “valve seat”, “damping force generation mechanism”, and “damping force adjustment mechanism” for convenience. Alternatively, the present invention can be applied to any structure including a member which can move in one axial direction and change an area of a flow path through which a fluid for generating a damping force flows.

The damping force adjustment mechanism of the present invention is suitable for a hydraulic shock absorber of a two-wheeled vehicle.

1. A damping force generation structure comprising:
a damping force generation mechanism having a valve seat and configured to generate a damping force; and
a damping force adjustment mechanism having a valve body advanceable and retractable relative to the valve seat, and configured to be able to adjust the damping force generated by the damping force adjustment mechanism, wherein:
the damping force generation mechanism and the damping force adjustment mechanism are fixed to each other via a fixing member along an advancing and retracting direction of the valve body;
the damping force adjustment mechanism includes:
a drive mechanism configured to be able to drive the valve body; and
a coupling member having a first end fixed to the drive mechanism and a second end fixed to the fixing member, thereby coupling the drive mechanism and the fixing member; and
at least one of a position of the damping force generation mechanism relative to the fixing member, a position of the coupling member relative to the fixing member, and a position of the drive mechanism relative to the coupling member is adjustable in the advancing and retracting direction of the valve body by a position adjustment mechanism.

2. The damping force generation structure according to claim 1, wherein
the damping force generation mechanism and the fixing member are integrated.

3. The damping force generation structure according to claim 1, wherein:
the drive mechanism includes a drive shaft configured to advance and retract the valve body; and
a transmission member which transmits a force generated by the drive mechanism from the drive shaft to the valve body is disposed between the drive shaft and the valve body.

4. The damping force generation structure according to claim 1, wherein
the position adjustable by the position adjustment mechanism is regulated by a regulation member.

5. The damping force generation structure according to claim 1, wherein
the position adjustment mechanism has a female thread and a male thread configured to be able to mesh with the female thread.

6. The damping force generation structure according to claim 5, wherein
the male thread and the female thread are fixed to each other by being located in a reference position and rotating the male thread or the female thread in a direction of loosening the male thread and the female thread from the reference position.

7. The damping force generation structure according to claim 6, wherein
the reference position is a fully closed position in which the valve body is in contact with the valve seat, or a fully open position in which an interval between the valve body and the valve seat is largest.

8. A shock absorber comprising:
the damping force generation structure according to claim 1.

9. The damping force generation structure according to claim 2, wherein:
the drive mechanism includes a drive shaft configured to advance and retract the valve body; and
a transmission member which transmits a force generated by the drive mechanism from the drive shaft to the valve body is disposed between the drive shaft and the valve body.

10. The damping force generation structure according to claim 2, wherein
the position adjustable by the position adjustment mechanism is regulated by a regulation member.

11. The damping force generation structure according to claim 2, wherein
the position adjustment mechanism has a female thread and a male thread configured to be able to mesh with the female thread.

12. The damping force generation structure according to claim 11, wherein
the male thread and the female thread are fixed to each other by being located in a reference position and rotating the male thread or the female thread in a direction of loosening the male thread and the female thread from the reference position.

13. A shock absorber comprising:
the damping force generation structure according to claim 2.

14. The damping force generation structure according to claim 3, wherein
the position adjustable by the position adjustment mechanism is regulated by a regulation member.

15. The damping force generation structure according to claim 3, wherein
the position adjustment mechanism has a female thread and a male thread configured to be able to mesh with the female thread.

16. The damping force generation structure according to claim 15, wherein
the male thread and the female thread are fixed to each other by being located in a reference position and rotating the male thread or the female thread in a direction of loosening the male thread and the female thread from the reference position.

17. A shock absorber comprising:
the damping force generation structure according to claim 3.

18. The damping force generation structure according to claim 4, wherein
the position adjustment mechanism has a female thread and a male thread configured to be able to mesh with the female thread.

19. A shock absorber comprising:
the damping force generation structure according to claim 4.

20. A shock absorber comprising:
the damping force generation structure according to claim 5.
